(19) United States
(12) Patent Application Publication
(10) Pub. No.: US 2003/0011956 A1
(43) Pub. Date: Jan. 16, 2003

(54) Negative ion generator

(76) Inventors: Yoshiaki Aiki, Tokyo (JP); Wakao Sakamoto, Aomori (JP)

Correspondence Address: WENDEROTH, LIND & PONACK, L.L.P., 2033 K STREET N. W., SUITE 800, WASHINGTON, DC, 20006-1021, US

(21) Appl. No.: 10/184,687

(22) Filed: Jul. 3, 2002

(30) Foreign Application Priority Data
Jul. 11, 2001 (JP) 2001-210251

(51) Int. Cl. H01T 23/00

(52) U.S. Cl. 361/230

(57) ABSTRACT

It is sought to provide a negative ion generator, which can generate negative ions in an optimum quantity corresponding to the working environment.

The negative ion generator 1 comprises a positive ion detecting means 2 for detecting positive ions in air, a negative ion generating means 3 for emitting electrons with a negative high voltage impressed on a stylus electric discharge electrode 12, and a control circuit for varying the negative high voltage impressed on the stylus electric discharge electrode in the negative ion generating means for generating negative ions in a quantity corresponding to the positive ion quantity detected by the positive ion detecting means.

### BACKGROUND OF THE INVENTION

1. Field of the Invention

This invention relates to negative ion generators, which can detect the quantity of positive ions in air which are undesired for the living body and generate suitable quantities of negative ions matching the environments.

2. Pior Art

Up to date, negative ions which have desired influence on the living body such as healthy effects for preventing oxidization of the human body, effect of holding freshness of food and deodorizing effects, are attracting attention. As means for artificially generating negative ions, various negative ion generators are present, which negatively charge gas molecules such as oxygen molecules and fine particles in air, that is, generate negative ions, by emitting electrons from the tip of a stylus electric discharge electrode with negative high voltage impression thereon.

While these convenient negative ion generators for easily generating negative ions are present, they should have resort to their on-off means for controlling the quantity of generated negative ions. However, in such environment as one in which many positive ions are present, it is necessary to generate many negative ions capable of canceling the positive ions. Also, in an environment in which some quantity of negative ions are present, it is necessary to finely control the quantity of generated negative ions in dependence on the environment to a corresponding sufficient quantity.

However, controlling the quantity of generated negative ions with the on-off means of the negative ion generator, may result in generation of an insufficient quantity of negative ions in the working environment or conversely result in generation of such an excessive quantity of negative ions as to be harmful to the human body. Actually, it has been impossible to control the quantity of generated negative ions best suited for the environment.

In a different aspect, in the prior art negative ion generator a high voltage generator circuit for generating a high voltage to be impressed on the stylus electric discharge electrode, uses a usual coil type high voltage transformer. However, the coil type high voltage causes electromagnetic wave generation because it executes electromagnetic coupling amplification. The electromagnetic wave generation results in generation of positive ions having adverse effects on the human body such as action of oxidizing the human body.

### SUMMARY OF THE INVENTION

The invention has an object of providing a negative ion generator, which can generate an optimum quantity of negative ions for the working environment while suppressing the positive ion generation as much as possible.

To attain this object, according to the invention a negative ion generator is provided, which comprises a positive ion detecting means for detecting positive ions in air, a negative ion generating means for causing electron emission from a stylus electric discharge electrode with negative high voltage impression thereon, and a control circuit for controlling the negative high voltage to be impressed on the stylus discharge electrode in the negative ion generating means in such a manner as to generate a quantity of negative ions corresponding to the quantity of positive ions detected by the positive ion detecting means.

### BRIEF DESCRIPTION OF THE DRAWINGS

FIG. 1 is a view showing a negative ion generator according to the invention; and

FIG. 2 is a graph showing the relation between output voltage and drive frequency of a piezoelectric transformer in the negative ion generator according to the invention.

### DETAILED DESCRIPTION OF THE PREFERRED EMBODIMENTS

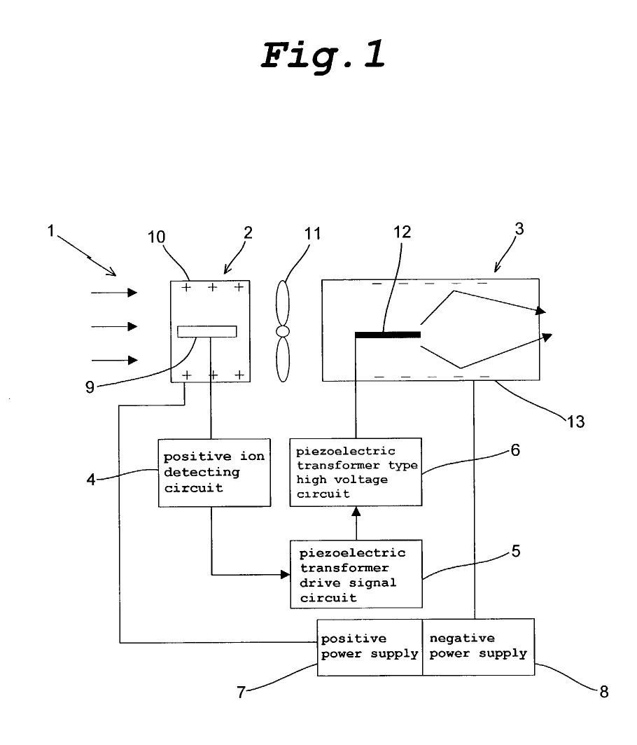

FIG. 1 shows a negative ion generator according to the invention. This negative ion generator 1 comprises a positive ion detecting means 2, a negative ion generating means 3, a positive ion detecting circuit 4, a piezoelectric transformer drive signal circuit 5, a piezoelectric transformer type high voltage circuit 6, a positive power supply 7 and a negative power supply 8.

The positive ion detecting means 2 includes a charge collector electrode 9 which is charged when struck by positive ions in air, a positive ion detection air passage 10 surrounding the charge collector electrode 9 and passing air through the inside, and an air passing member 11 constituted by a motor-driven fan for passing air through the inside of the positive ion detection air passage 10. The positive ion detecting circuit 4 measures charge on the charge collector electrode 9, which has been charged by collecting positive ions, and computes the number of positive ions per unit time and unit volume. The positive ion detection air passage 10 is connected to the positive power supply 7 and charged to a positive potential for repelling positive ions taken into the air passage so as to let the repelled positive ions be collected on the charge collector electrode 9.

The negative ion generating means 3 includes a stylus electric discharge electrode 12 for generating negative ions by electron emission with impression of a negative high voltage generated by the piezoelectric transformer type high voltage circuit 6, and a negative ion induction air passage 13, which surrounds the stylus electric discharge electrode 12 and passes air from the air passing member 11 to the inside for adequately inducing negative ions to the outside. The negative ion induction air passage 13 is charged by the negative power supply 8 to a negative potential lest it should attract and reduce negative ions emitted from the stylus electric discharge electrode 12.

A control circuit for the negative ion generator 1 is constituted by the positive ion detecting circuit 4, the piezoelectric transformer drive signal circuit 5 and the piezoelectric transformer type high voltage circuit 6. The positive ion detecting circuit 4 detects charge on the charge collector electrode 9 and generates a voltage corresponding to the computed number of positive ions per unit time and unit volume, the generated voltage being outputted as control signal to the piezoelectric transformer type drive signal circuit 5. The piezoelectric transformer drive signal circuit 5 receives a control signal, controls the drive frequency to a frequency (of ±5 kHz, for instance), in the neighborhood of the resonant frequency (of 75 kHz, for instance) of the piezoelectric transformer, and outputs the voltage at the controlled frequency as AC voltage for driving the piezoelectric transformer to the piezoelectric transformer type high voltage circuit 6.

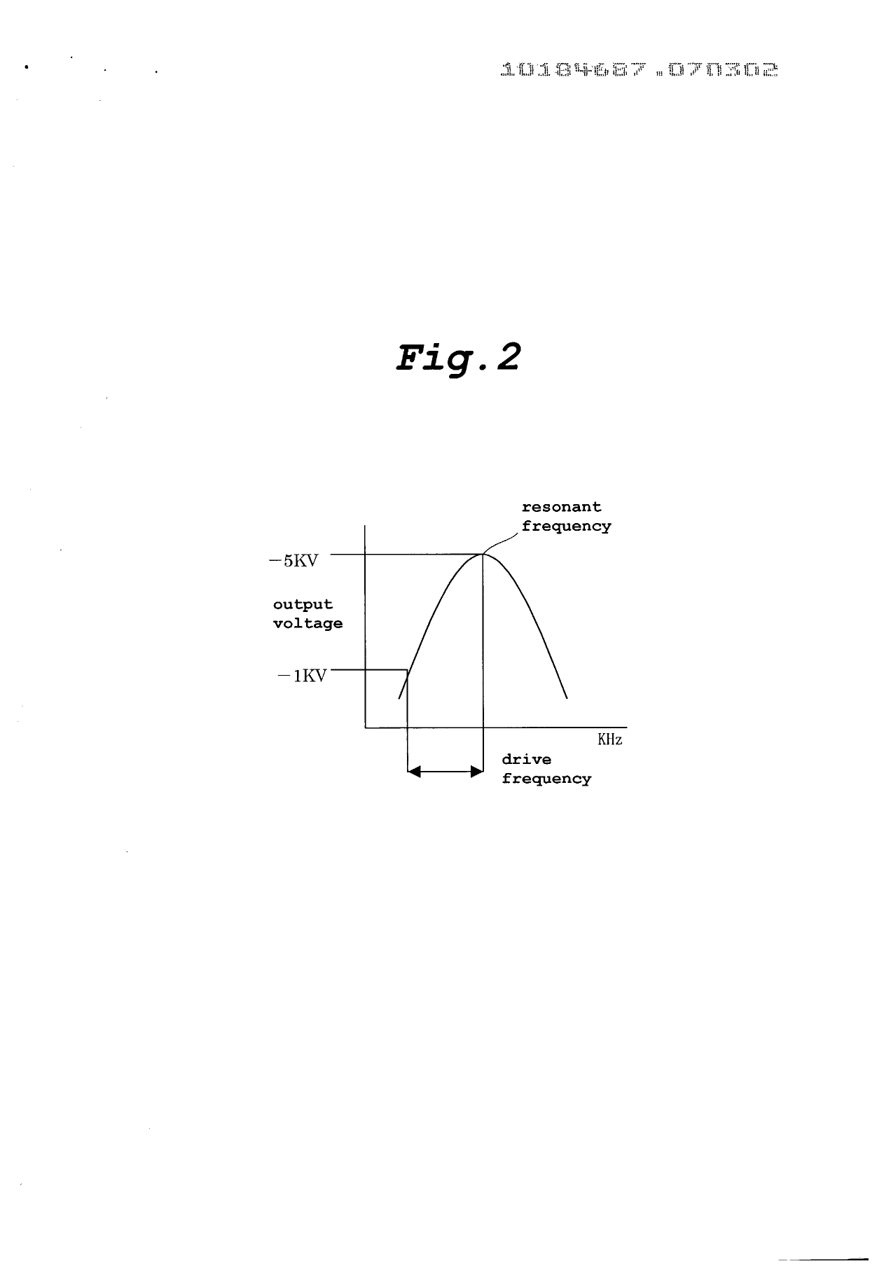

FIG. 2 shows the relation between output voltage and drive frequency of the piezoelectric transformer. The piezoelectric transformer output voltage can be greatly changed by changing the drive frequency from the piezoelectric transformer drive signal circuit 5 by several kHz.

The piezoelectric transformer in the piezoelectric transformer high voltage circuit 6 is a small-size, thin and highly efficient transformer. When an AC voltage in the neighborhood of the resonant frequency is impressed on its input electrode, mechanical oscillations of the whole piezoelectric body are caused by converse piezoelectric effect. These mechanical oscillations are led as a higher voltage to the output electrode by the piezoelectric effect. The higher voltage that is outputted is in a range of −1 to −5 kHz depending on the frequency of the AC voltage from the piezoelectric transformer drive signal circuit 5. As shown, the piezoelectric transformer, unlike the prior art coil type high voltage transformer, does not perform electromagnetic coupling amplification. Thus, it is possible to suppress the positive ion generation due to electromagnetic wave as much as possible. The above high voltage is fed to a rectifying circuit to generate a negative high voltage, which is impressed on the stylus electric discharge electrode 12 for electron emission from the tip of the electrode 12, thereby generating negative ions. The generated negative ions are passed by air passing operation of the air passing member 11 through the negative ion induction air passage 13 and emitted to the outside thereof without being attracted and reduced in the air passage 13.

Although not particularly shown, it is possible to provide a display part for displaying the number of positive ions in the working environment as detected by the positive ion detecting means.

As has been described in the foregoing, the negative ion generator according to the invention is constituted by a positive ion detecting means for detecting positive ions in air, a negative ion generating means for emitting electrons with a negative high voltage impressed on an electric discharge electrode, and a control circuit for controlling the negative high voltage to be impressed on the electric discharge electrode in the negative ion generating means for generating negative ions in a quantity corresponding to the positive ion quantity detected by the positive ion detecting means. Thus, it is possible to detect positive ions in a working environment and generate an optimum quantity of negative ions corresponding to the working environment, thus creating an environment which is useful for the living body.

The positive ion detecting means includes a charge collector electrode disposed in the air passage and collecting positive ions in air and a repelling electrode disposed to face the charge collector electrode and charged to a positive polarity. Thus, positive ions in air entering the air passage can be repelled by the repelling electrode to be effectively collected on the charge collector electrode. It is thus possible to accurately detect positive ions.

The negative ion generating means includes an electric discharge electrode disposed in the air passage and a negative ion induction air passage surrounding the electric discharge electrode and charged to a negative potential. Thus, negative ions emitted form the electric discharge electrode can be efficiently discharged to the outside by the air passing means without being attracted as a result of being repelled by the surrounding like polarity negative ion induction air passage.

The negative ion generating means includes a high voltage generation circuit using a piezoelectric transformer and, unlike the prior art coil type high voltage transformer, does not perform any electromagnetic coupling amplification. Thus, it is possible to suppress positive ion generation due to electromagnetic wave as much as possible and suitably generate negative ions. In addition, since the piezoelectric transformer is thin and small in size compared to the coil type high voltage transformer, it is possible to reduce the thickness and size of the negative ion generator.

What is claimed is:

1. A negative ion generator comprising a positive ion detecting means for detecting positive ions in air, a negative ion generating means for emitting electrons with a negative high voltage impressed on an electric discharge electrode, and a control circuit for varying the negative high voltage impressed on the electric discharge electrode in the negative ion generating means for generating negative ions in a quantity corresponding to the positive ion quantity detected by the positive ion detecting means.

2. The negative ion generator according to claim 1, wherein the positive ion detecting means includes a charge collector electrode disposed in an air passage for collecting positive ions in air and a repelling electrode disposed to face the charge collector electrode and charged to a positive polarity.

3. The negative ion generator according to claim 1, wherein the negative ion generating means includes an electric discharge electrode disposed in the air passage and a negative ion induction air passage surrounding the electric discharge electrode and charged to a negative potential.

4. The negative ion generator according to claim 1, wherein the negative ion generating means includes a high voltage generating circuit using a piezoelectric transformer.
